(19) United States
(12) Patent Application Publication
(10) Pub. No.: US 2020/0238914 A1
(43) Pub. Date: Jul. 30, 2020

(54) VEHICLE SIDE VIEW MIRROR WITH ELECTRONIC BLIND SPOT DISPLAY

(71) Applicant: Toyota Motor Engineering & Manufacturing North America, Inc., Plano, TX (US)

(72) Inventors: Faleh ALMAHMOUD, Belleville, MI (US); Ryan C. Harris, Saline, MI (US)

(73) Assignee: Toyota Motor Engineering & Manufacturing North America, Inc., Plano, TX (US)

(21) Appl. No.: 16/262,078

(22) Filed: Jan. 30, 2019

(51) Int. Cl. B60R 1/12; H04N 5/247; H04N 5/232; G08G 1/16; B60R 1/06; B60R 1/00; B60Q 9/00; B60R 11/04

(52) U.S. Cl. CPC B60R 1/12; H04N 5/247; H04N 5/23203; G08G 1/167; H04N 17/002; B60R 1/00; B60R 1/1207; B60Q 9/00; B60R 11/04; B60R 1/06

(57) ABSTRACT

A vehicle side mirror for rear and side view is provided. The side mirror includes a side mirror case, a light permeable reflective glass arranged inside the side mirror case. The light permeable reflective glass is configured to present an image reflected from side and rear of the vehicle, and provide a first field of view. The side mirror also includes a camera that is configured to record a live video captured from the side and rear of the vehicle, and provide a second field of view. The side mirror includes a display screen disposed between the reflective glass and the side mirror case. The display screen is configured to display the live video recorded by the camera. The side mirror further has a control switch installed in the vehicle. The control switch configured to switch the camera and the display screen between an activated status and a deactivated status.

### BACKGROUND

For driving safety, vehicle side mirrors are usually installed at two sides of a vehicle to readily observe positions and directions of rear or side approaching vehicles. Thus, when a vehicle switches lanes or turns, accidents such as collisions with other vehicles can be prevented.

However, a conventional side mirror has blind spots and is hard to present the entire field of the rear side. Thus, a driver must risk many dangers when he/she changes the driving lane. During operation of a vehicle, poor vision of the side mirror may cause a traffic accident. Therefore, the conventional side mirror has room to improve. For example, the U.S. Pat. No. 7,777,611 B2, “Display Device For Exterior Rearview Mirror”, discloses a mirror reflective element sub-assembly for an exterior rear view mirror assembly of a vehicle that includes a mirror reflective element and a video display element. The video display element is disposed behind the mirror reflective element so that images displayed by the video display element are viewable through the mirror reflective element when the video display element is activated.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure aims to improve a side mirror's field of view and reduce vehicle blind spots by utilizing a camera and an electronic display built into the side mirror. The built-in display is only visible when the screen is activated, otherwise, the side mirror can be used as a traditional mirror.

In a related example, an electronic rearview mirror is introduced where a screen is present behind the reflective portion of the mirror. Such a configuration allows digital media to be displayed. Other related examples include side view camera systems that completely eliminate the presence of a mirror. While effective at reducing vehicle blind spots, such systems rely on only a camera and software to provide the driver with a side view image. It can be dangerous to rely on the camera and software fully for checking rearview because a camera or software failure would result in substantially reduced visibility and bring in significant safety concern for the driver. Consequently, a camera-only side view system may not be approved by some regulatory bodies.

In the present disclosure, an incorporation of a display into a side view mirror provides convenience and added safety due to a reduced blind spot. Such a configuration also is less prone to failure compared to a camera-only system, because a traditional mirror is still accessible in case of a camera or software failure. As a result, the present disclosure is more likely to be approved by regulatory bodies.

In the present disclosure, a screen can be integrated into a side mirror to display a live video from a camera to show a blind spot area of a vehicle. The camera can be incorporated into the side view mirror assembly. Alternatively, the cameras may be placed at different locations on the vehicle like the rear bumper and doors, for example.

In one embodiment, the display screen can be placed behind the reflective part of the mirror. Such a configuration allows the display screen to be activated when additional side view visibility is desired, and deactivated when the driver would prefer to use the mirror. Digital video cameras may not always accurately capture the dynamics of an image, leading to overly bright or dark images that make it difficult for a driver to observe the surrounding environment. In such situations, it may be beneficial to utilize the traditional side view mirrors. Moreover, in the event of a camera or software failure, the display screen may be deactivated to allow the driver to use the traditional mirrors to navigate.

In Another embodiment of the present disclosure, the display of the live video can be restricted to only a portion of the mirror, which would enable the driver to monitor a vehicle's blind spot via the live video, and also be able to review a reflected image of the side view obtained from the traditional mirrors.

According to an aspect of the present disclosure, a vehicle side mirror for rear and side view is provided. The side mirror includes a side mirror case, a light-permeable reflective glass arranged inside the side mirror case. The reflective glass is configured to present an image reflected from side and rear of the vehicle, and provide a first field of view. The side mirror also includes a camera that is configured to record a live video captured from the side and rear of the vehicle, and provide a second field of view. The side mirror includes a display screen disposed between the reflective glass and the side mirror case. The display screen is configured to display the live video recorded by the camera. The side mirror further has a control switch installed in the vehicle. The control switch configured to switch the camera and the display screen between an activated status and a deactivated status.

In the disclosed vehicle side mirror, the light-permeable reflective glass presents the image reflected from the side and rear of the vehicle when the camera and the display screen are deactivated by the control switch. The light-permeable reflective glass presents the live video displayed on the display screen when the camera and the display screen are activated by the control switch.

In the disclosed side mirror, the second field of view is larger than the first field of view so that a vehicle blind spot is reduced.

In some embodiments, the light-permeable reflective glass has a transmittance of 25 to 35% so that light of the display screen penetrates the light-permeable reflective glasses and the live video displayed on the display screen presents on the light-permeable reflective glass.

In some embodiments, the disclosed side mirror further includes a first sensor configure to sense a distance between the vehicle and one or more adjacent vehicles. The side mirror can have a second sensor configure to sense a weather condition. Further, an audio device can be integrated into the vehicle and the audio device is configured to receive an oral instruction and output an audio alarm. The side mirror can include a light emitting device configured to output an alarm light. The side mirror can also have a microprocessor configured to process input signals from the control switch, the first sensor, the second sensor, the camera, or the audio device and output an instruction to the camera, the audio device, or the display screen.

In some embodiments, the camera is arranged at a perimeter of the side mirror case, a car door, a rear bumper, or a rear trunk of the vehicle. In some embodiments, the light emitting device outputs the alarm light when the first sensor detects that a distance between the vehicle and the one or more adjacent vehicles is smaller than a distance limit.

In some embodiments, the audio device outputs the audio alarm when the first sensor senses that the distance between the vehicle and the one or more adjacent vehicles is smaller than the distance limit. Further, the display screen presents alarm message when the first sensor senses that the distance between the vehicle and the one or more adjacent vehicles is smaller than the distance limit.

In an embodiment, the camera and the display screen are deactivated when the second sensor detects an adverse weather condition. In another embodiment, the camera and the display screen are deactivated when the microprocessor detects a camera failure or a software failure.

In an embodiment, only a portion of the light-permeable reflective glass presents the live video that is displayed on the display screen when the camera and the display screen are activated by the control switch. In another embodiment, a full screen of light-permeable reflective glass presents the live video that is displayed on the display screen when the camera and the display screen are activated by the control switch.

According to another aspect of the present disclosure, a method for improving a side mirror's field of view is provided. In the disclosed method, one or more cameras are incorporated into a vehicle. The one or more cameras are configured to record a live video captured from side and rear of the vehicle, and provide an extended field of view. In the disclosed method, a display screen is also arranged between a light-permeable reflective glass and a side mirror case of a side mirror. The display screen is configured to display the live video recorded by the camera. Subsequently, in the disclosed method, the one or more cameras and the display screen are activated via a switch control, and the live video that is displayed on the display screen is presented via the light-permeable reflective glass to a driver.

In the disclosed method, a weather condition can be sensed via a second sensor. The one or more cameras and the display screen are deactivated when the second sensor detects an adverse weather condition.

In yet another aspect of the present disclosure, an apparatus for reducing a blind spot of a vehicle is provided. The apparatus includes a side mirror where the side mirror has a side mirror case, a light-permeable reflective glass arranged inside the side mirror case, and a display screen disposed between the reflective glass and the side mirror case. The apparatus also have one or more cameras that are arranged at least at one of a perimeter of the side mirror case, a car door, a rear bumper, and a rear trunk of the vehicle. The cameras are configured to record a live video captured from side and rear of the vehicle. In the disclosed apparatus, a control switch is installed in the vehicle. The control switch is configured to switch the camera and the display screen between an activated status and a deactivated status. The apparatus further includes a sensor configured to sense a weather condition, and a microprocessor. The microprocessor is configured to process input signals from the control switch, the sensor, sensor, or the camera, and output an instruction to the camera, or the display screen.

By utilizing a camera and an electronic display screen built into a side mirror, the present disclosure improves the side mirror's field of view and reduces vehicle blind spots. Comparing to related examples, the disclosed side mirror has an improved reliability in that the built-in display screen is only visible when the screen is activated, otherwise, the side mirror can be used as a traditional mirror. The built-in display screen can be activated or deactivated manually via a control switch by the driver. The built-in display screen can also be deactivated automatically via a sensor when the sensor detects an adverse weather condition. The built-in display screen can further be deactivated automatically via a microprocessor when the microprocessor detects a camera failure of a software failure. Comparing to related examples, the disclosed side mirror brings improvements both in driving safety and system reliability.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of an exemplary side mirror for rear and side view, in accordance with some embodiments.

FIG. 2 is an illustration of a perspective view of the exemplary side mirror for rear and side view, in accordance with some embodiments.

FIG. 3A is an illustration of a first exemplary way that the side mirror presents a live video for rear and side view, in accordance with some embodiments.

FIG. 3B is an illustration of a second exemplary way that the side mirror presents a live video for rear and side view, in accordance with some embodiments.

FIG. 3C is an illustration of a third exemplary way that the side mirror presents a live video for rear and side view, in accordance with some embodiments.

FIG. 3D is illustration of a fourth exemplary way that the side mirror presents a live video for rear and side view, in accordance with some embodiments.

FIG. 4 is a schematic diagram illustrating two field of views of the side mirror, in accordance with some embodiments.

FIG. 5 is a block diagram schematically showing a circuitry of the side mirror, in accordance with some embodiments.

FIG. 6 is a flowchart outlining an exemplary operation of the side mirror, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Driving safety is important to a driver or a passenger of a vehicle. In the current disclosure, an apparatus and a method are disclosed to provide an extended field of view from side and rear of the vehicle. The expanded field of view reduces vehicle blind spots and gains driving safety to a driver. In addition, the disposed apparatus has improved system reliability comparing to the related examples.

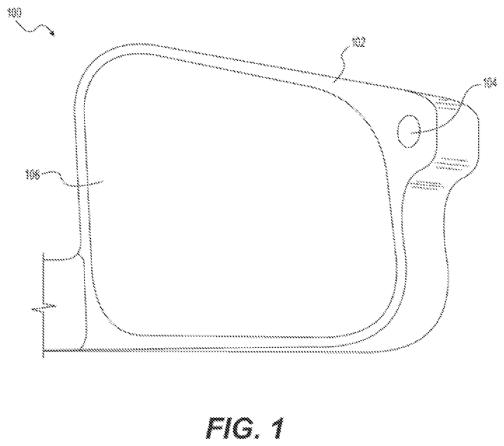

FIG. 1 is an illustration of an exemplary side mirror 100 for rear and side view. As shown in FIG. 1, the side mirror 100 can have a side mirror case 102, a light-permeable reflective glass 106 arranged inside the side mirror case, and a camera 104. The light permeable reflective glass 106 presents an image that is reflected from side and rear of the vehicle, and the image provides a first field of view. The camera 104 is configured to record a live video captured from the side and rear of the vehicle, and the live video provides a second field of view. In some embodiments, the camera 104 can be arranged at a perimeter of the side mirror case 102, as shown in FIG. 1. In some embodiments, the camera 104 can be positioned in a car door, a rear bumper, or a rear trunk of the vehicle. The camera 104 can be a visible light camera or an infrared camera.

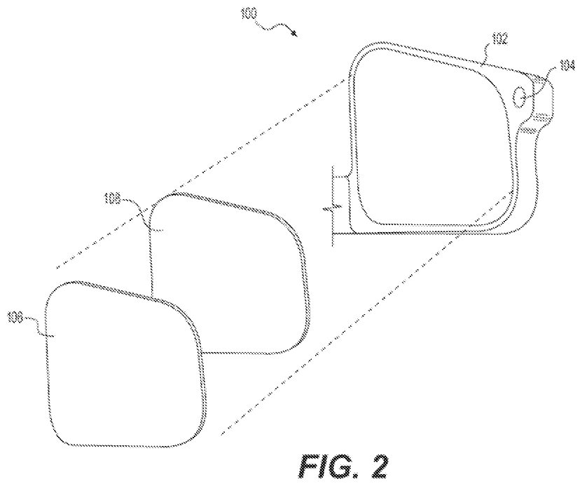

FIG. 2 an illustration of a perspective view of the exemplary side mirror 100. As shown in FIG. 2, a display screen 108 is disposed between the reflective glass 106 and the side mirror case 102. The display screen 108 is configured to display the live video recorded by the camera. The display screen 108 can be liquid crystal display (LCD) screen, an organic light-emitting diode (OLED) screen, or the like.

The light permeable reflective glass 106 can be a transflective glass that is partially transmissive and partially reflective, so that light emanating from the display screen 108 can be transmitted through the reflective glass 106 when the display screen 108 is activated. Thus, the reflective glass 106 allows the display screen 108 to be viewable through the reflective glass when the display screen is active, and also provides a mirror function and is viewed as a reflecting mirror when the display screen 108 is deactivated. In some embodiments, the light permeable reflective glass 106 can have a transmittance of 25% to 35% so that the light of the display screen penetrates the light-permeable reflective glasses and the live video displayed on the display screen can be presented through the light-permeable reflective glass.

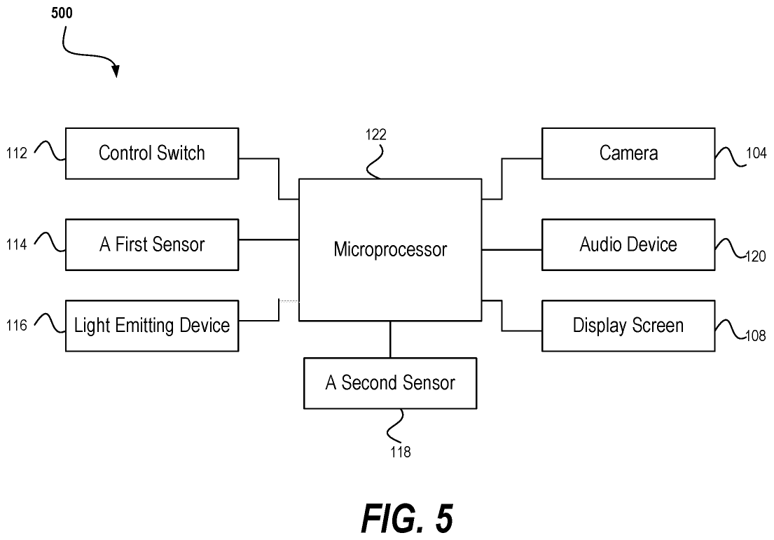

Still referring to FIG. 2, when the vehicle runs in a normal state, the display screen 108 neither works nor projects light to the backside of the light permeable reflective glass 106. Thus, the light permeable reflective glass 106 functions like the conventional reflecting mirror and reflects the image of the rear and side of the vehicle. However, when the vehicle turns left or right, or when the driver turns on a control switch that is shown in FIG. 5, the camera 104 and the display screen 108 can be activated. The camera 104 captures a live video from the side and rear of the vehicle. The live video is subsequently transmitted to the display screen 108 for display. When the display screen 108 is turned on, the light thereof penetrates the light permeable reflective glass 106 and the live video captured form the rear and side of the vehicle is exhibited through the light permeable reflective glass 106, and the driver can thus directly observe the status of the corresponding rear side. Thereby, the driver can judge the conditions more accurately.

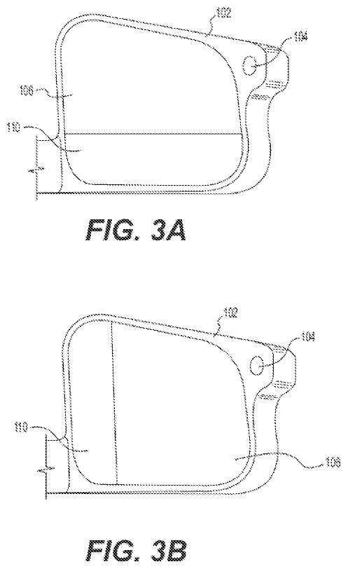

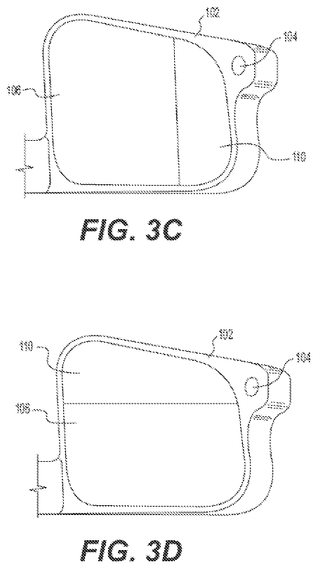

FIGS. 3A-3D provides different ways that the live video can be presented through the light permeable reflective glass 106. In some embodiments, the live video can be presented through a full area of the light permeable reflective glass 106. In some embodiments, the live video can be presented through a portion of the light permeable reflective glass 106. For example, FIG. 3A illustrates a first scenario where the live video 110 is presented through a bottom portion of the reflective glass 106. FIG. 3B illustrates a second scenario where the live video 110 is presented through a left portion of the reflective glass 106. FIG. 3C illustrates a third scenario where the live video 110 is presented through a right portion of the reflective glass 106. FIG. 3D illustrates a fourth scenario where the live video 110 is presented through a top portion of the reflective glass 106. It should be noted that FIGS. 3A-3D are merely examples, and the live video 110 can be presented through other locations of the reflective glass 106.

In some embodiments, two or more cameras are integrated into the vehicle. For example, one is mounted in the side mirror case as shown in FIG. 1, and the other is mounted in the rear truck (not shown). Accordingly, each of the cameras can record a respective live video. The live videos captured by the cameras can be presented at different locations of the reflective glass 106.

When the live video is presented through a portion of the reflective glass 106, the side mirror 100 accordingly provides both a reflected image captured by the reflective glass 106 from the rear and side of the vehicle and a live video captured by the camera 104 from the rear and side of the vehicle. Such a configuration can gain additional field of view and improve the driving safety.

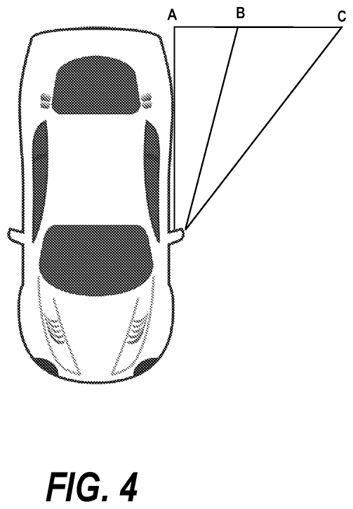

FIG. 4 is a schematic diagram illustrating two field of views of the side mirror 100, in accordance with some embodiments. When the camera 104 and the display screen 108 are not activated, the reflective glass 106 functions as the conventional reflecting mirror and presents the image that is reflected from the side and rear of the vehicle. Accordingly, the side mirror 100 provides the first field of view to the driver based on the image of the reflective glass 106. The first field of view can be a region labelled as A-B in FIG. 4. When the camera 104 and the display screen 108 are activated, the reflective glass 106 transmits the live video that is captured by the camera 104 and displayed on the display screen 108. Accordingly, the side mirror 100 provides the second field of view to the driver based on the live video. The second field of view can be another region labelled as A-C in the FIG. 4. As shown in FIG. 4, the second field of view is bigger than the first field of view. By incorporating the camera 104 and the display screen 108 into the side mirror 100, an extended field of view can be obtained and a vehicle blind spot can be reduced correspondingly.

FIG. 5 is a block diagram schematically showing a circuitry 500 of the side mirror. The circuitry 500 can include the camera 104, the display screen 108, a control switch 112, a first sensor 114, a light emitting device 116, a second sensor 118, an audio device 120, and a microprocessor 122.

The microprocessor 122 can be a well-known microcomputer or a processor having CPU (central processing unit), ROM (read only memory), RAM (random access memory) and I/O (input and output) interface. The microprocessor 122 is configured to process input signals from the control switch 112, the first sensor 114, the second sensor 118, the camera 104, or the audio device 120, and output an instruction to the camera 104, the audio device 120, the light emitting device 116, or the display screen 108.

As mentioned above, the camera 104 can be a visible light camera or an infrared camera. The camera 104 can be configured to capture visual data from the side and rear of the vehicle to generate a live video. In an embodiment illustrated in FIG. 5, the camera 104 is a visible light camera and the live video acquired by the camera 104 can be used for providing the driver a road condition of the blind spots. The camera 104 can be mounted on the side mirror, front, rear, top, sides, or other locations of the vehicle depending on the technology requirement.

The display screen 108 is configured to display the live video recorded by the camera 104. The display screen 108 can be electrically coupled to the camera 104 and the microprocessor 122. When the camera 104 is activated, the camera 104 captures visual data from the rear and side of the vehicle. The visual data is sent to the microprocessor 122 for signal processing. The processed visual data is further transmitted by the microprocessor 122 to the display screen 108 for display. The display screen 108 can be a cathode ray tube display (CRT), a light-emitting diode display (LED), an electroluminescent display (ELD), a liquid crystal display (LCD), an organic light-emitting diode display (OLED), or the like.

The control switch 112 is installed in the vehicle, such as in an instrument panel of the vehicle. The control switch 112 is configured to switch the camera 104 and the display screen 108 between an activated status and a deactivated status. The control switch 112 has an input terminal, such as a touchscreen or a keyboard, to receive an instruction from the driver. The instruction input by the driver is subsequently transmitted to the microprocessor 122. The microprocessor 122 further activates or deactivates the camera 104 and the display screen 108 according to the instruction.

The first sensor 114 is configured to sense a distance between the vehicle and one or more adjacent vehicles. The first sensor can be a radar, a sonar, a Light Detection and Ranging (LIDAR) sensor, or the like. The first sensor can generate a signal and transmit the signal to the microprocessor 122 for processing. The microprocessor can process the signal of the first sensor to detect the distance between the vehicle and adjacent vehicles.

The second sensor 118 can be a weather sensor and is configured to sense weather condition. The second sensor 118 can accurately measure outdoor conditions, such as temperature, humidity, rainfall, wind speed, wind direction. The measured data is further transmitted to the microprocessor 122 for data analysis. When the microprocessor 122 detects an adverse weather condition, such as rain, fog, ice, snow, and dust, the microprocessor 122 can send an instruction to deactivate the camera 104 and the display screen 108.

The audio device 120 disclosed in FIG. 5 can serve as an audio input device that is configured to receive an audio signal and convert the audio signal into an electrical signal. The converted electrical signal is further sent to the microprocessor 122 for signal processing. In an embodiment of FIG. 5, the audio device 120 can include a microphone. In an example of the current disclosure, the driver can send an oral request to activate or deactivate the camera 104. When the oral request is received by the microphone, the microphone converts the oral request into an electrical signal, and sends the electrical signal to the microprocessor 122 for signal processing. Upon completion of the signal processing on the electrical signal from the microphone, the microprocessor 122 can identify the request of the driver and activate or deactivate the camera 104 accordingly.

The audio device 120 can also be audio output device, and is configured to turn an electrical signal into an audio signal. In an embodiment of FIG. 5, the audio device 120 can include a speaker. When the microprocessor 122, based on the signal transmitted from the first sensor 114, detects that the distance between the vehicle and the adjacent vehicles is smaller than a distance limit, the microprocessor 122 can send an alarm signal to the audio device 120. The audio device 120 subsequently transforms the alarm signal into an audio message to the driver.

Still referring to FIG. 5, a light emitting device 116 can also be incorporated in the vehicle. In an embodiment, the light emitting device 116 can be positioned in the instrument panel of the vehicle. The light emitting device 116 can include a light emitting diode, such as a LED diode, a laser diode, or the like. The light emitting device 116 is configured to output an alarm light. For example, when the microprocessor 122, based on the signal transmitted from the first sensor 114, detects that the distance between the vehicle and the adjacent vehicles is smaller than the distance limit, the microprocessor 122 can send an alarm signal to the light emitting device. The light emitting device subsequently outputs the alarm signal as a flash warning light to the driver.

In some embodiments, the display screen 108 can also be able to present an alarm message when the first sensor 114 senses that the distance between the vehicle and the one or more adjacent vehicles is smaller than the distance limit.

In some embodiments, the camera 104 and the display screen 108 are deactivated when the microprocessor detects a camera failure or a software failure.

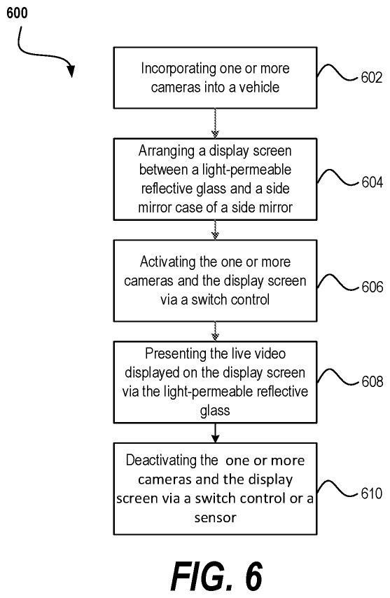

FIG. 6 is a flowchart 600 outlining an exemplary operation of the side mirror 100. The flowchart 600 starts with step 602 where one or more cameras are incorporated into a vehicle. The cameras can be arranged at a perimeter of the side mirror case, a car door, a rear bumper, or a rear trunk of the vehicle. At step 604, a display screen can be incorporated into a side mirror. The side mirror has a reflective glass and a side mirror case. The reflective glass is a light-permeable reflective glass that is arranged inside the side mirror case. The display screen can be disposed between the reflective glass and the side mirror case. The display screen configured to display the live video recorded by the cameras. The light-permeable reflective glass has a transmittance of 25% to 35% so that light of the display screen penetrates the light-permeable reflective glasses and the live video displayed on the display screen can be presented through the light-permeable reflective glass.

The flowchart 600 then proceeds to step 606 where the one or more cameras and the display screen can be activated via a switch control. In some embodiment, the one or more cameras and the display screen can also be activated via an audio device by the driver. When the cameras and the screen are turned on, the cameras start to record road conditions from the rear and side of the vehicle, and generate a live video. The live video is further transmitted to the display screen for play.

At step 608, the live video that is displayed on the display screen is presented through the light-permeable reflective glass to the driver. Comparing to an image presented by the light-permeable reflective glass, the live video provides an extended field of view from the rear and side of the vehicle, and reduces the vehicle blind spots.

The flowchart 600 then proceeds to step 610. At step 610, the cameras and the display screen can be deactivated via the control switch by the driver manually. The cameras and the display screen can also be deactivated by a weather sensor that is incorporated in the vehicle. The weather sensor can deactivate the cameras and the display screen when an adverse weather is detected. The adverse weather can include rain, fog, ice, snow, dust, or the like.

In the present disclosure, a novel method and an apparatus for improving a side mirror's field of view and reducing vehicle blind spots are provided. By incorporating a camera and an electronic display screen into a side mirror, the present disclosure improves the side mirror's field of view and reduces vehicle blind spots. Comparing to related examples, the disclosed side mirror has an improved reliability in that the built-in display screen is only visible when the screen is activated, otherwise, the side mirror functions as a traditional mirror. The built-in display screen can be activated or deactivated manually via a control switch by the driver. The built-in display screen can also be deactivated automatically via a sensor when the sensor detects an adverse weather condition. The built-in display screen can further be deactivated automatically via a microprocessor when the microprocessor detects a camera failure of a software failure. Comparing to related examples, the disclosed side mirror brings improvements both in driving safety and system reliability.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1: A vehicle side mirror for rear and side view, comprising:
a side mirror case;
a light permeable reflective glass arranged inside the side mirror case, the light permeable reflective glass configured to present an image reflected from side and rear of the vehicle, the image providing a first field of view;
a camera disposed on a door of the vehicle and configured to record a live video captured from the side and rear of the vehicle, the live video providing a second field of view;
a display screen disposed between the reflective glass and the side mirror case, the display screen being configured to display the live video recorded by the camera; and
a control switch installed in the vehicle, the control switch being configured to switch the camera and the display screen between an activated status and a deactivated status;
wherein the light-permeable reflective glass presents the image reflected from the side and rear of the vehicle when the camera and the display screen are deactivated, and wherein the light permeable reflective glass presents the live video displayed on the display screen when the camera and the display screen are activated.

2: The vehicle side mirror of claim 1, wherein the second field of view is larger than the first field of view so that a vehicle blind spot is reduced.

3: The vehicle side mirror of claim 1, wherein the light permeable reflective glass has a transmittance of 25% to 35% so that light of the display screen penetrates the light permeable reflective glasses and the live video displayed on the display screen is viewable through the light-permeable reflective glass.

4: The vehicle side mirror of claim 1, further comprising:
a first sensor configured to sense a distance between the vehicle and one or more adjacent vehicles;
a second sensor configured to sense a weather condition;
an audio device configured to receive an oral instruction and output an audio alarm;
a light emitting device configured to output an alarm light; and
a microprocessor configured to process input signals from the control switch, the first sensor, the second sensor, the camera, or the audio device and output an instruction to the camera, the audio device, the light emitting device, or the display screen.

5. (canceled)

6: The vehicle side mirror of claim 4, wherein the light emitting device outputs the alarm light when the first sensor senses that the distance between the vehicle and the one or more adjacent vehicles is smaller than a distance limit.

7: The vehicle side mirror of claim 4, wherein the audio device outputs the audio alarm when the first sensor senses that the distance between the vehicle and the one or more adjacent vehicles is smaller than a distance limit.

8: The vehicle side mirror of claim 4, wherein the display screen presents an alarm message when the first sensor senses that the distance between the vehicle and the one or more adjacent vehicles is smaller than a distance limit.

9: The vehicle side mirror of claim 4, wherein the camera and the display screen are deactivated when the second sensor senses an adverse weather condition.

10: The vehicle side mirror of claim 4, wherein the camera and the display screen are deactivated when the microprocessor detects a camera failure or a software failure.

11: The vehicle side mirror of claim 1, wherein a portion of the light permeable reflective glass presents the live video that is displayed on the display screen when the camera and the display screen are activated.

12: A method for improving side mirror field of view, comprising:
incorporating one or more cameras into a door of a vehicle, the one or more cameras being configured to record a live video captured from side and rear of the vehicle to provide an extended field of view;
arranging a display screen between a light permeable reflective glass and a side mirror case of a side mirror, the display screen configured to display the live video recorded by the camera; and
activating the one or more cameras and the display screen via a switch control, the live video displayed on the display screen being presented through the light permeable reflective glass.

13. (canceled)

14: The method of claim 12, further comprising:
sensing a distance between the vehicle and one or more adjacent vehicles via a first sensor; and
presenting an alarm message via the display screen when the first sensor detects that the distance between the vehicle and the one or more adjacent vehicles is smaller than a distance limit.

15: The method of claim 12, further comprising:
sensing a weather condition via a second sensor;
deactivating the one or more cameras and the display screen when the second sensor detects an adverse weather condition.

16: The method of claim 12, further comprising:
deactivating the one or more cameras and the display screen when a camera failure or a software failure is detected by a microprocessor.

17: The method of claim 12, wherein the extended field of view is larger than a field of view obtained via the light-permeable reflective glass.

18: An apparatus for reducing a blind spot of a vehicle, comprising:
a side mirror, the side mirror including a side mirror case, a light permeable reflective glass arranged inside the side mirror case, and a display screen disposed between the reflective glass and the side mirror case;
one or more cameras disposed on a door of the vehicle and configured to record a live video captured from side and rear of the vehicle;
a control switch installed in the vehicle, the control switch configured to switch the one or more cameras and the display screen between an activated status and a deactivated status;
a sensor configured to sense a weather condition; and
a microprocessor configured to process input signals from the control switch, the sensor, or the one or more cameras, and output an instruction to the one or more cameras, and the display screen.

19: The apparatus of claim 18, wherein a portion of the light permeable reflective glass presents the live video that is displayed on the display screen when the camera and the display screen are activated by the control switch.

20: The apparatus of claim 18, wherein the camera and the display screen are deactivated when the sensor senses an adverse weather condition.
